(19) United States
(12) Patent Application Publication
(10) Pub. No.: US 2012/0175512 A1
(43) Pub. Date: Jul. 12, 2012

(54) RAYLEIGH SCATTER-BASED LARGE DIAMETER WAVEGUIDE SENSOR SYSTEM

(75) Inventors: Roger G. Duncan, Christiansburg, VA (US); Brooks A. Childers, Christiansburg, VA (US)

(73) Assignee: BAKER HUGHES INCORPORATED, Houston, TX (US)

(21) Appl. No.: 12/985,698

(22) Filed: Jan. 6, 2011

(51) Int. Cl. G01V 8/10

(52) U.S. Cl. 250/269.1

(57) ABSTRACT

Disclosed is an apparatus for estimating a parameter in a borehole penetrating the earth. The apparatus includes a large diameter waveguide (LDW) sensor configured to be disposed in the borehole and to sense the parameter at one or more locations along the LDW sensor, the LDW sensor having an outer dimension greater than or equal to 0.25 mm and random variations of an optical property. An optical interrogator is coupled to the LDW sensor and configured to illuminate the LDW sensor with incident light at a swept frequency and to receive light from the large diameter waveguide due to Rayleigh scattering of the incident light by the random variations of the optical property along a length of the LDW sensor. The received light provides information for estimating the parameter and a location along the LDW sensor where the parameter was sensed.

### BACKGROUND

1. Field of the Invention

The invention disclosed herein relates to measuring a physical parameter in a downhole environment using an optical waveguide.

2. Description of the Related Art

Boreholes are drilled deep into the earth for many applications such as carbon dioxide sequestration, geothermal production, and hydrocarbon exploration and production. Many different types of tools and instruments may be disposed in the boreholes to perform various tasks. Typically, very high pressures, temperatures and vibrations are encountered by the tools and instruments when they are disposed deep in the earth.

In many instances, the tools and instruments include one or more sensors for measuring a parameter such as pressure, temperature, or force. Optical fibers are known to be able to survive high pressures and temperatures and are used for measuring pressure or temperature in a borehole in addition to providing downhole communications. However, the small size of optical fibers may make the fibers prone to buckling under compressive force and cause distorted measurements or mechanical failure. It would be well received in the drilling and completion industry if optical sensors could be improved to increase measurement accuracy, precision, and mechanical reliability in addition to lowering their cost of production.

### BRIEF SUMMARY

Disclosed is an apparatus for estimating a parameter in a borehole penetrating the earth. The apparatus includes a large diameter waveguide (LDW) sensor configured to be disposed in the borehole and to sense the parameter at one or more locations along the LDW sensor, the LDW sensor having an outer dimension greater than or equal to 0.25 mm and random variations of an optical property. An optical interrogator is coupled to the LDW sensor and configured to illuminate the LDW sensor with incident light at a swept frequency and to receive light from the large diameter waveguide due to Rayleigh scattering of the incident light by the random variations of the optical property along a length of the LDW sensor. The received light provides information for estimating the parameter and a location along the LDW sensor where the parameter was sensed.

Also disclosed is a method for estimating a parameter in a borehole penetrating the earth. The method includes: disposing a large diameter waveguide (LDW) sensor into the borehole, the LDW sensor having an outer dimension greater than or equal to 0.25 mm and random variations of an optical property along a length of the LDW sensor; illuminating the LDW sensor with incident light at a swept frequency; receiving light from the LDW sensor due to Rayleigh scattering of the incident light; and estimating the parameter and a location along the LDW sensor where the parameter was sensed using the received light.

Further disclosed is a non-transitory computer-readable medium comprising instructions for estimating a parameter in a borehole penetrating the earth. The instructions implement a method that includes: illuminating a large diameter waveguide (LDW) sensor disposed in the borehole with incident light at a swept frequency, the LDW sensor having an outer dimension greater than or equal to 0.25 mm and random variations of an optical property along a length of the LDW sensor; receiving light from the LDW sensor due to Rayleigh scattering of the incident light; and estimating the parameter and a location along the LDW sensor where the parameter was sensed using the received light.

### BRIEF DESCRIPTION OF THE DRAWINGS

The following descriptions should not be considered limiting in any way. With reference to the accompanying drawings, like elements are numbered alike:

FIG. 1 illustrates an exemplary embodiment of a large diameter waveguide sensor disposed in a borehole penetrating the earth;

FIG. 2 depicts aspects of the large diameter waveguide sensor that uses total internal reflection for light confinement;

FIG. 3 depicts aspects of an embodiment of the large diameter waveguide sensor that uses photonic bandgap effects for light confinement;

FIG. 4 depicts aspects of another embodiment of the large diameter waveguide sensor that uses photonic bandgap effects for light confinement; and

FIG. 5 presents one example of a method for measuring a parameter within the borehole.

### DETAILED DESCRIPTION

A detailed description of one or more embodiments of the disclosed apparatus and method is presented herein by way of exemplification and not limitation with reference to the Figures.

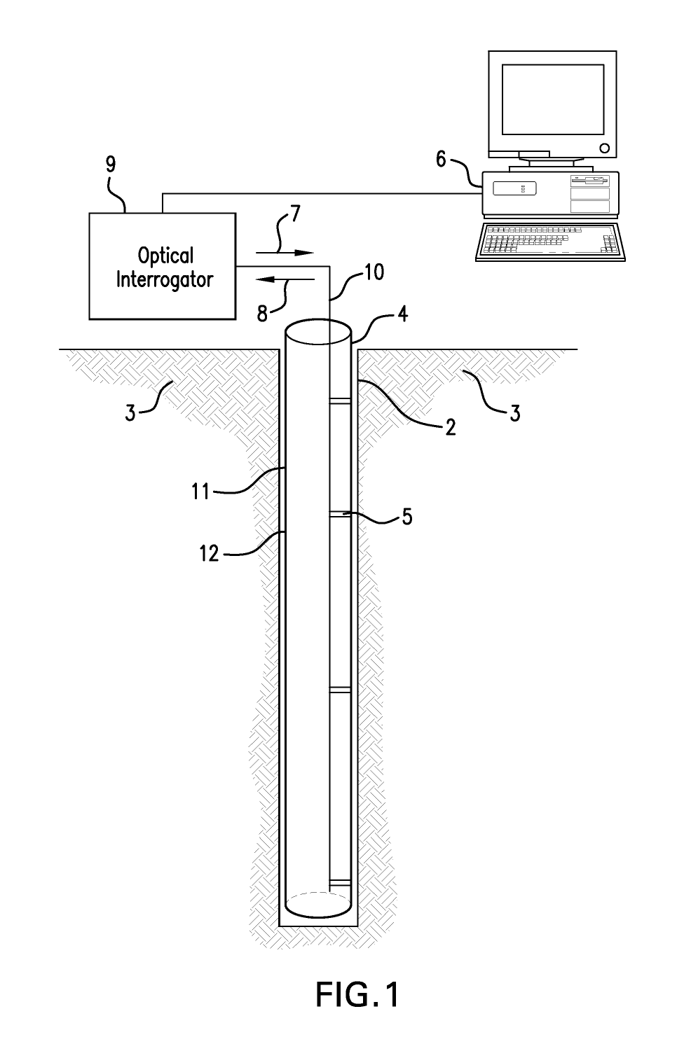

FIG. 1 illustrates an exemplary embodiment of a large diameter waveguide (LDW) sensor 10 disposed in a borehole 2 penetrating the earth 3. The LDW sensor 10 is coupled to a downhole structure 11 disposed in the borehole 2 such as a casing 12. The LDW sensor 10 is configured to measure a parameter downhole. Non-limiting embodiments of the parameter include pressure, temperature, force, or strain. The parameter can be a parameter that exists downhole (such as pressure or temperature) or a parameter that is associated with the downhole structure 11 (such as strain). In the embodiment of FIG. 1, the LDW sensor 10 is attached to the downhole structure 11 using attachment devices 5. The attachment devices 5 transfer one or more parameters such as strain or temperature experienced by the downhole structure 11 to the LDW sensor 10 for measurement. Non-limiting embodiments of the attachments devices 5 include mechanical fasteners and adhesive.

Still referring to FIG. 1, the LDW sensor 10 is coupled to an optical interrogator 9. The optical interrogator 9 is configured to transmit incident light 7 into the LDW sensor 10 and to receive received light 8 from the LDW sensor 10. The received light 8 is due to the incident light 7 under going Rayleigh scattering in the LDW sensor 10. Rayleigh scatter or backscatter is caused by fluctuations in the profile of the index of refraction along the length of the LDW sensor 10. For a given LDW sensor 10, the scatter amplitude of the received light 8 as a function of distance along the LDW sensor 10 is a random but static or fixed property of that LDW sensor 10. In one embodiment, the scatter amplitude of the received light 8 can be modeled as coming from a continuous weak fiber Bragg grating having a random period although a fiber Bragg grating is not written into the LDW sensor 10.

The received light 8 due to Rayleigh scattering is monitored by the optical interrogator 9. The monitoring can include measuring the amplitude and wavelength of the received light 8 and correlating the amplitude to a location along the LDW sensor 10. To monitor the received light 8 in one embodiment, the optical interrogator is based on swept-wavelength interferometry.

In swept-wavelength interferometry, the optical interrogator 9 illuminates the LDW sensor 10 with the light 7 with wavelengths of light swept about various wavelengths of reflected light. The fluctuations in the profile of the index of refraction along the length of the LDW sensor 10 create various optical interferometric cavities along the length of the LDW sensor 10. The swept wavelengths of the incident light 7 illuminating the LDW sensor 10 create an interferogram from light interferences due to the various optical interferometric cavities. The interferogram is a data or image record of the light interferences with each light interference having a reflection wavelength and a magnitude. The optical interrogator 9 is configured to receive the light 8 to measure the various wavelengths and magnitudes, which are used to create the interferogram. The interferogram may be created by the optical interrogator 9 or by a computer processing system 6 coupled to the optical interrogator 9.

From the interferogram, measurement data may be obtained from locations along the length of the LDW sensor 10. The measurement data is associated with a change in a physical characteristic of the LDW sensor 10 due to an external stimulus such as strain or temperature for example. The change in the physical characteristic results in a change in the local period of the Rayleigh scatter, which in turn causes a shift in the locally reflected spectrum (i.e., a change in the interferogram). In general, a wavelength of the received light 8 identifies a location along the LDW sensor 10 at which a measurement is performed and an amplitude associated with the wavelength provides measurement data (i.e., strain or temperature for example). Thus, by observing a change in the interferogram, a change in a parameter can be measured. In one embodiment, a calibrated interferogram is created with reference to a calibrated standard. Interferogram changes may then be referenced to the calibrated interferogram to provide a calibrated measurement. Local spectral shifts can then be assembled to form a distributed measurement.

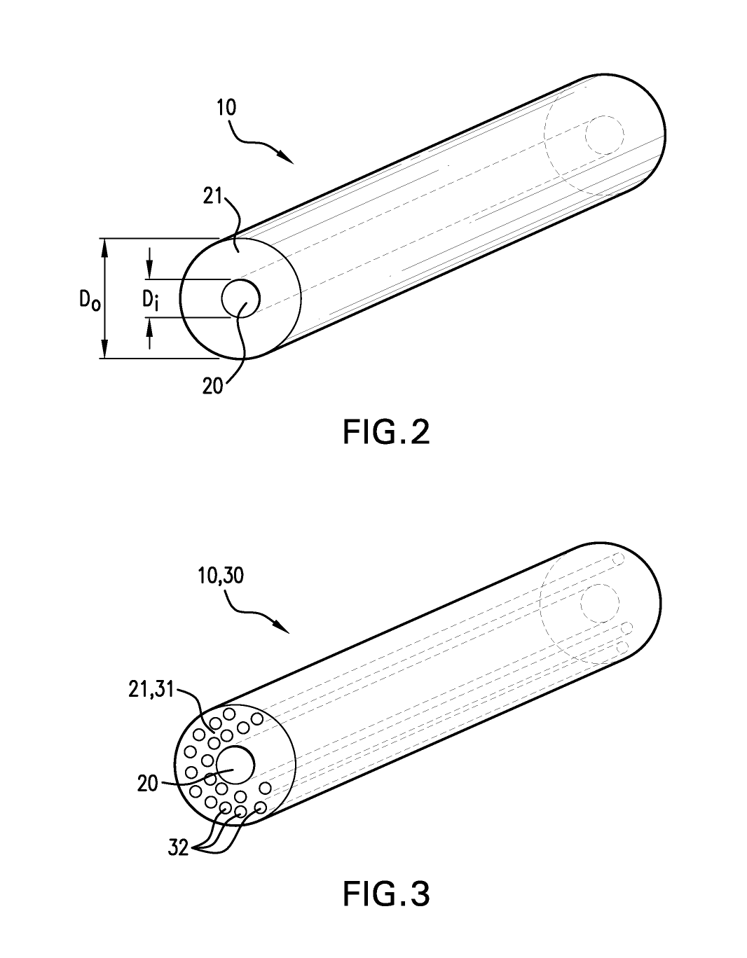

Reference may now be had to FIG. 2 depicting aspects of the LDW sensor 10 using total internal reflection for the transmission of the light 7 and 8. The LDW sensor 10 includes an inner core 20 disposed in a cladding 21. Not shown is a protective sleeve that may surround the cladding 21 for protection purposes. In the embodiment of FIG. 2, the inner core 20 has an index of refraction that is greater than the index of refraction of the cladding 21, which causes light in the inner core 20 to be reflected by the cladding 21. The outside diameter Dₒ of the cladding 21 is at least 0.25 mm or about at least twice as much as the outside diameter of a standard telecommunications fiber optic waveguide. This minimum dimension provides the structural integrity that allows the application of high compressive forces, the enabling of high mechanical reliability, and more stable, precise and accurate measurements. In one embodiment, the ability to withstand high compressive forces without buckling allows for the measurement of high pressures and strain with increased accuracy. It can be appreciated that the outside diameter Dₒ of the cladding 21 can be up to several millimeters for more increased structural integrity. The outside diameter Dᵢ of the inner core 20 is defined to select a desired number of spatial modes for propagation. In one embodiment the outside diameter Dᵢ of the inner core 20 is less than about 12.5 microns.

The inner core 20 of the LDW sensor 10 can be made of any glass or plastic or any combination thereof having intrinsic properties that produce Rayleigh scattering of incident light. Exemplary embodiments of the glass include silica glass and phosphate glass.

While the LDW sensor 10 in the embodiment of FIG. 2 illustrates one inner core 20 disposed in the cladding 21, it can be appreciated that more than one inner core 20 can be disposed in the cladding 21. The additional inner cores 20 can be used to provide multiple measurements at specific locations (1) to improve accuracy, (2) for redundancy purposes in case of failure of one core 20, or (3) for providing differential measurements for various purposes such as measuring shape.

It can be appreciated that either the inner core 20 or the cladding 21 can have cross-sectional shapes other than the circular shapes depicted in FIG. 2.

Reference may now be had to FIG. 3 depicting aspects of the LDW sensor 10 using processes other than total internal reflection for the transmission of the incident light 7 and the received light 8. The LDW sensor 10 in the embodiment of FIG. 10 is a large diameter photonic-crystal fiber (LDPCF) 30 having dimensions similar to the LDW sensor 10 in FIG. 2. In the LDPCF 30, the cladding 21 is a micro-structure 31 configured to confine light due to photonic bandgap effects. The LDPCF 30 includes the inner core 20 surrounded by the micro-structure 31, which runs parallel to the inner core 20. The micro-structure 21, which can be periodic or aperiodic, causes the LDPCF 30 to act as photonic crystal. In the embodiment of FIG. 3, the micro-structure 31 includes a plurality of channels 32. The channels 32 in one embodiment can be voids or holes, which provide air or gas spaces.

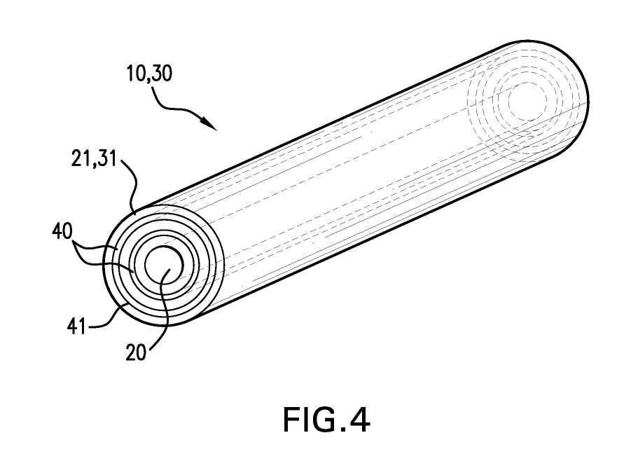

Reference may now be had to FIG. 4, which depicts aspects of another configuration of the micro-structure 31. In the embodiment of FIG. 4, the micro-structure 31 includes a plurality of concentric rings 40 of a multilayer film 41 to guide light using photonic bandgap effects.

It can be appreciated that Rayleigh scattering of light in the LDW sensor 10 is intrinsic to the inner core 21 and that the LDW sensor 10 does not have a sensing section with a predefined beginning and end. As such, a sensing length of interest can be defined to suit the application (i.e., only measurements over the sensing length of interest are read).

It can be appreciated that the LDW sensor 10 can be produced at low cost using existing optical fiber preform glass deposition equipment, and drawn on a draw tower that is modified to accommodate draw diameters up to several millimeters.

It can be appreciated that the LDW sensor 10 may be deployed over long lengths, which can require high optical power. A standard optical fiber sensor may sustain damage when illuminated with such high optical power. Hence, one advantage of the LDW sensor 10 is that it can be deployed over longer lengths than the standard optical fiber sensor.

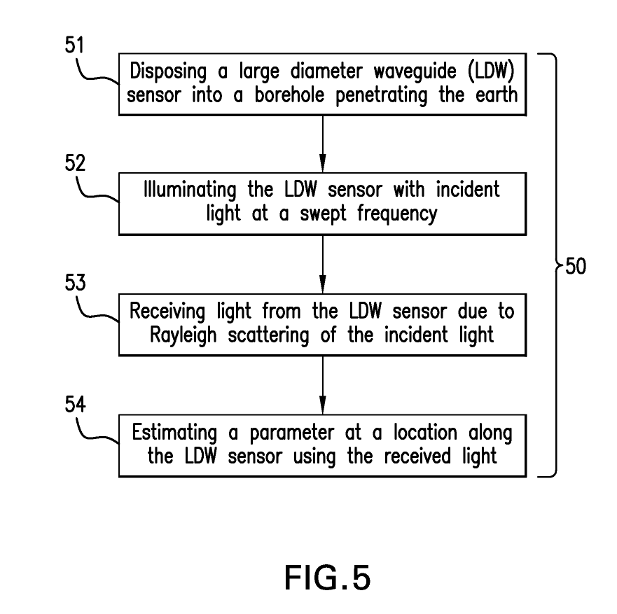

FIG. 5 presents one example of a method 50 for estimating a parameter in a borehole penetrating the earth. The method 50 calls for (step 51) disposing a large diameter waveguide sensor into the borehole. Further, the method calls for (step 52) illuminating the large diameter waveguide sensor with incident light at a swept frequency. Further, the method calls for (step 53) receiving light from the large diameter waveguide sensor due to Rayleigh scattering of the incident light. This step can include measuring a wavelength and amplitude of the received light and creating an interferogram. Further, the method calls for (step 54) estimating the parameter at a location along the large diameter waveguide using the received light. This step can include using the interferogram to estimate the parameter and the location of the parameter measurement.

In support of the teachings herein, various analysis components may be used, including a digital and/or an analog system. For example, the optical interrogator 9 or the computer processing 6 may include the digital and/or analog system. The system may have components such as a processor, storage media, memory, input, output, communications link (wired, wireless, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, optical lenses, optical couplers, optical splitters, optical combiners, optical splices, lasers, photodetectors, frequency counters, interferometers, electrical units, electro-optical units or electromechanical units may be included in support of the various aspects discussed herein or in support of other functions beyond this disclosure.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for estimating a parameter in a borehole penetrating the earth, the apparatus comprising:
a large diameter waveguide (LDW) sensor configured to be disposed in the borehole and to sense the parameter at one or more locations along the LDW sensor, the LDW sensor having an outer dimension greater than or equal to 0.25 mm and random variations of an optical property along a length of the LDW sensor; and
an optical interrogator configured to illuminate the LDW sensor with incident light at a swept frequency and to receive light from the large diameter waveguide due to Rayleigh scattering of the incident light by the random variations of the optical property along a length of the LDW sensor;
wherein the received light provides information for estimating the parameter and a location along the LDW sensor where the parameter was sensed.

2. The apparatus according to claim 1, wherein the parameter is at least one of pressure, temperature, force, strain and shape.

3. The apparatus according to claim 1, wherein the LDW sensor comprises an inner core disposed within a cladding having the outer dimension, the inner core having the random variation of the optical property and being configured to receive the incident light.

4. The apparatus according to claim 3, wherein the optical property is an index of refraction.

5. The apparatus according to claim 1, wherein the cladding comprises a material having an index of refraction less than the index of refraction of the inner core.

6. The apparatus according to claim 1, wherein the cladding comprises a micro-structure configured to confine light in the inner core by photonic bandgap effects.

7. The apparatus according to claim 6, wherein the micro-structure comprises a plurality of channels disposed parallel to the inner core.

8. The apparatus according to claim 1, wherein the channels define holes.

9. The apparatus according to claim 1, wherein the micro-structure comprises a plurality of concentric rings of multilayer film disposed around the inner core.

10. The apparatus according to claim 1, wherein the optical interrogator is configured to create an interferogram from the received light.

11. The apparatus according to claim 10, wherein the interferogram provides a measurement of the parameter and a location along the LDW sensor where the measurement was performed.

12. The apparatus according to claim 1, further comprising a structure configured to be disposed in the borehole and coupled to LDW sensor.

13. The apparatus according to claim 12, wherein the structure is a casing configured to be disposed in the borehole.

14. A method for estimating a parameter in a borehole penetrating the earth, the method comprising:
disposing a large diameter waveguide (LDW) sensor into the borehole, the LDW sensor having an outer dimension greater than or equal to 0.25 mm and random variations of an optical property along a length of the LDW sensor;
illuminating the LDW sensor with incident light at a swept frequency;
receiving light from the LDW sensor due to Rayleigh scattering of the incident light; and
estimating the parameter and a location along the LDW sensor where the parameter was sensed using the received light.

15. The method according to claim 14, further comprising measuring an amplitude and wavelength of the received light.

16. The method according to claim 15, further comprising creating an interferogram from the received light.

17. The method according to claim 24, wherein estimating comprises using the interferogram to estimate the parameter and the location along the LDW sensor where the parameter was sensed.

18. A non-transitory computer-readable medium comprising instructions for estimating a parameter in a borehole penetrating the earth by implementing a method comprising:
illuminating a large diameter waveguide (LDW) sensor disposed in the borehole with incident light at a swept frequency, the LDW sensor having an outer dimension greater than or equal to 0.25 mm and random variations of an optical property along a length of the LDW sensor;
receiving light from the LDW sensor due to Rayleigh scattering of the incident light; and
estimating the parameter and a location along the LDW sensor where the parameter was sensed using the received light.
